(19) United States
(12) Patent Application Publication
(10) Pub. No.: US 2018/0201041 A1
(43) Pub. Date: Jul. 19, 2018

(54) NOTEBOOK SYSTEM CAPABLE OF REPLACING STACKS OF ONE -SIDE-BOUND INNER PAPER SHEETS

(71) Applicant: Kyoungsook Park, Donghae-si (KR)

(72) Inventor: Kyoungsook Park, Donghae-si (KR)

(21) Appl. No.: 15/746,425

(22) PCT Filed: Sep. 11, 2015
(86) PCT No.: PCT/KR2015/009567

§ 371 Date: Jan. 22, 2018

(30) Foreign Application Priority Data
Jul. 23, 2015 (KR) 10-2015-0104066

(51) Int. Cl. B42D 3/00; B42D 1/06; B42D 3/10; B42D 3/12

(52) U.S. Cl. CPC B42D 3/00; B42D 1/06; B42D 3/10; B42D 15/00; B42P 2241/04; B42P 2241/18; B42D 3/12

(57) ABSTRACT

The present disclosure provides a novel notebook system in which stacks of one-side-bound inner paper sheets are replaced, wherein a plurality of pockets are formed at a plurality of positions in an inner face of an outermost cover sheet, a first or last paper sheet of the stack of one-side-bound inner paper sheets is removably inserted into the pocket selected by the user, and, therefore, the handwriting direction or position may be freely changed according to the user's selection. According to the present disclosure, the user can freely change the position of the stack of one-side-bound inner paper sheets, and thus can make notes or handwriting in a convenient way. When the stack of one-side-bound inner paper sheets are completely used, the stack may be replaced with a new stack of one-side-bound inner paper sheets, which can save money and waste material.

### BACKGROUND

### Field of the Present Disclosure

The present disclosure relates to the notebook system, which can replace stacks of one-side-bound inner paper sheets therein. More specifically, the present disclosure relates to the notebook system in which stacks of one-side-bound inner paper sheets may be replaced, wherein a plurality of pockets are formed at a plurality of positions in an inner face of an outermost cover sheet, a first or last paper sheet of the stack of one-side-bound inner paper sheets may be removably inserted into the pocket selected by the user, and, therefore, the handwriting direction or position may be freely changed according to the user's selection.

### Discussion of Related Art

Typically, a notebook is used to write or draw on an inner paper sheet therein. A stack of one-side-bound inner paper sheets is attached to the center folding line of the outermost cover sheet with an adhesive.

Further, the outermost cover sheet embeds a single stack of one-side-bound inner paper sheets therein. The handwriting takes place sequentially from the first page to the last page of the single stack of one-side-bound inner paper sheets.

Recently, the outermost cover sheet embeds multiple stacks of one-side-bound inner paper sheets therein. Thus, different contents may be written on different stacks of one-side-bound inner paper sheets respectively.

FIG. 1 and FIG. 2 are perspective views showing the structure of a multi-stage notebook system according to the related art.

The multi-stage notebook 10 according to the related art is configured as follows. The main outermost cover sheet 11 may be folded around the center folding line. A first stack of one-side-bound inner paper sheets 12 is attached to the inner face of the main outermost cover sheet 11 at the center folding line. A left longitudinal cover sheet extension 13 is coupled to a left edge of the outermost cover sheet 11. The left longitudinal cover sheet extension 1 is folded or unfolded in the longitudinal direction. A right longitudinal cover sheet extension 14 is coupled to a right edge of the outermost cover sheet 11, wherein the right longitudinal cover sheet extension 14 is folded or unfolded in the longitudinal direction. A second stack of one-side-bound inner paper sheets 15 is attached to a second folding line between the left longitudinal cover sheet extension 13 and a left edge of the outermost cover sheet 11. A third stack of one-side-bound inner paper sheets 16 is attached to a third folding line between the right longitudinal cover sheet extension 14 and a right edge of the outermost cover sheet 11.

The first to third stacks of one-side-bound inner paper sheets may be used for various purposes. Therefore, versatile handwriting purposes may be realized using a single notebook system.

However, in the notebook system shown in FIGS. 1 and 2, the first stack of one-side-bound inner paper sheets is fixed to the inner face of the main outermost cover sheet at the center folding line. The second stack of one-side-bound inner paper sheets is fixed to a second folding line between the left longitudinal cover sheet extension and a left edge of the outermost cover sheet. The third stack of one-side-bound inner paper sheets is fixed to a third folding line between the right longitudinal cover sheet extension and a right edge of the outermost cover sheet. Thus, it is not possible to replace the stack of one-side-bound inner paper sheets. Positioning of the stack of one-side-bound inner paper sheets is not possible.

### SUMMARY

The present disclosure is to provide a novel notebook system in which stacks of one-side-bound inner paper sheets are replaced, wherein a plurality of pockets are formed at a plurality of positions in an inner face of an outermost cover sheet, a first or last paper sheet of the stack of one-side-bound inner paper sheets is removably inserted into the pocket selected by the user, and, therefore, the handwriting direction or position may be freely changed according to the user's selection.

In a first aspect of the present disclosure, there is provided a notebook system comprising: an outermost cover sheet 102, wherein a first pocket 102a and a second pocket 102b are formed in an inner face of the sheet 102 and are adjacent to left and right sides of a central folding line of the outermost cover sheet 102, respectively, wherein a third pocket 102c and a fourth pocket 102d are formed in the inner face of the sheet 102 and are adjacent to a left side of the first pocket 102a and to a right side of the second pocket 102b, respectively, wherein a fifth pocket 102e and a sixth pocket 102f are formed in the inner face of the sheet 102 and are adjacent to a left edge and a right edge of the sheet 102, respectively; a first stack of one-side-bound inner paper sheets 104, wherein a first sheet 104a and a last sheet 104b of the first stack of one-side-bound inner paper sheets 104 are removably inserted into the first pocket 102a and the second pocket 102b, respectively, wherein the first stack has first writable paper sheets 104c disposed between the first and last sheets 104a and 104b; a second stack of one-side-bound inner paper sheets 106, wherein a first sheet 106a of the second stack of one-side-bound inner paper sheets 106 is removably inserted into the third pocket 102c, or a last sheet 106b of the second stack of one-side-bound inner paper sheets 106 is removably inserted into the fifth pocket 102e, wherein the second stack has second writable paper sheets 106c disposed between the first and last sheets 106a and 106b of the second stack of one-side-bound inner paper sheets 106; a third stack of one-side-bound inner paper sheets 108, wherein a last sheet 108b of the third stack of one-side-bound inner paper sheets 108 is removably inserted into the fourth pocket 102d, or a first sheet 108a of the third stack of one-side-bound inner paper sheets 108 is removably inserted into the sixth pocket 102f, wherein the third stack has third writable paper sheets 108c disposed between the first and last sheets 108a and 108b of the third stack of one-side-bound inner paper sheets 108; wherein each of the first, second, and third stacks is embodied as a blank paper sheets stack or an underlined paper sheets stack or a printed book having content printed thereon.

In second aspect of the present disclosure, there is provided a notebook system comprising: an outermost cover sheet 202, wherein a first pocket 202a and a second pocket 202b are formed in an inner face of the sheet 202 and are adjacent to left and right sides of a central folding line of the outermost cover sheet 202, respectively, wherein the cover sheet 202 is folded or unfolded in a longitudinal direction around the folding line; a transverse sheet extension 204 further foldably coupled to the outermost cover sheet 202, wherein the transverse sheet extension 204 is folded or unfolded in a transverse direction perpendicular to the longitudinal direction, wherein the extension 204 extends from a top or bottom edge of the cover sheet 202; a first stack of one-side-bound inner paper sheets 206, wherein a first sheet 206a and a last sheet 206b of the first stack of one-side-bound inner paper sheets 206 are removably inserted into the first pocket 202a and the second pocket 202b, respectively, wherein the first stack has first writable paper sheets 206c between the first and last sheets 206a and 206b of the first stack; and a second stack of one-side-bound inner paper sheets 208, wherein a last paper sheet 208a of the second stack of one-side-bound inner paper sheets 208 is removably inserted into a third pocket 202c, wherein the third pocket 202c is formed in an outer face of the sheet 202, wherein the second stack has second writable paper sheets 208b between first and last sheets of the second stack, wherein each of the first and second stacks is embodied as a blank paper sheets stack or an underlined paper sheets stack or a printed book having content printed thereon.

In a third aspect of the present disclosure, there is provided a notebook system comprising: an outermost cover sheet 302, wherein a first pocket 302a and a second pocket 302b are formed in an inner face of the sheet 302 and are adjacent to left and right sides of a central folding line of the outermost cover sheet 302, respectively, wherein a third pocket 302c and a fourth pocket 302d are formed in the inner face of the sheet 302 and are adjacent to a left side of the first pocket 302a and to a right side of the second pocket 302b, respectively, wherein a fifth pocket 302e and a sixth pocket 302f are formed in the inner face of the sheet 302 and are adjacent to a left edge and a right edge of the sheet 302, respectively, wherein the cover sheet 302 is folded or unfolded in a longitudinal direction around the folding line; a longitudinal cover sheet extension 304 coupled to a right edge of the outermost cover sheet 302, wherein the longitudinal cover sheet extension 304 is folded or unfolded in the longitudinal direction, wherein a seventh pocket 304a is formed in an inner face of the extension 304 and is adjacent to a left edge of the longitudinal cover sheet extension 304, wherein an eighth pocket 304b is formed in the inner face of the extension 304 and is adjacent to a right edge of the extension 304; a first stack of one-side-bound inner paper sheets 306, wherein a first sheet 306a and a last sheet 306b of the first stack of one-side-bound inner paper sheets 306 are removably inserted into the first pocket 302a and the second pocket 302b, respectively, wherein the first stack has first writable paper sheets 306c disposed between the first and last sheets 306a and 306b; a second stack of one-side-bound inner paper sheets 308, wherein a first sheet 308a of the second stack of one-side-bound inner paper sheets 308 is removably inserted into the third pocket 302c, or a last sheet 308b of the second stack of one-side-bound inner paper sheets 308 is removably inserted into the fifth pocket 302e, wherein the second stack has second writable paper sheets 308c disposed between the first and last sheets 308a and 308b of the second stack of one-side-bound inner paper sheets 308; a third stack of one-side-bound inner paper sheets 310, wherein a last sheet 310b of the third stack of one-side-bound inner paper sheets 310 is removably inserted into the fourth pocket 302d, or a first sheet 310a of the third stack of one-side-bound inner paper sheets 310 is removably inserted into the sixth pocket 302f, wherein the third stack has third writable paper sheets 310c disposed between the first and last sheets 310a and 310b of the third stack of one-side-bound inner paper sheets 310; and a fourth stack of one-side-bound inner paper sheets 312, wherein a last sheet 312b of the fourth stack of one-side-bound inner paper sheets 312 is removably inserted into the seventh pocket 304a, or a first sheet 312a of the fourth stack of one-side-bound inner paper sheets 312 is removably inserted into the eight pocket 304b, wherein the fourth stack has fourth writable paper sheets 312c disposed between the first and last sheets 312a and 312b of the fourth stack of one-side-bound inner paper sheets 312, wherein each of the first, second, third, and fourth stacks is embodied as a blank paper sheets stack or an underlined paper sheets stack or a printed book having content printed thereon.

In a fourth aspect of the present disclosure, there is provided a notebook system comprising: an outermost cover sheet 402, wherein a first pocket 402a and a second pocket 402b are formed in an inner face of the sheet 402 and are adjacent to left and right sides of a central folding line of the outermost cover sheet 402, respectively, wherein a third pocket 402c and a fourth pocket 402d are formed in the inner face of the sheet 402 and are adjacent to a left side of the first pocket 402a and to a right side of the second pocket 402b, respectively, wherein a fifth pocket 402e and a sixth pocket 402f are formed in the inner face of the sheet 402 and are adjacent to a left edge and a right edge of the sheet 402, respectively, wherein the cover sheet 402 is folded or unfolded in a longitudinal direction around the folding line; a left longitudinal cover sheet extension 404 coupled to a left edge of the outermost cover sheet 402, wherein the left longitudinal cover sheet extension 404 is folded or unfolded in the longitudinal direction, wherein a seventh pocket 404a is formed in an inner face of the extension 404 and is adjacent to a right edge of the longitudinal cover sheet extension 404, wherein an eighth pocket 404b is formed in the inner face of the extension 404 and is adjacent to a left edge of the extension 404; a right longitudinal cover sheet extension 406 coupled to a right edge of the outermost cover sheet 402, wherein the right longitudinal cover sheet extension 406 is folded or unfolded in the longitudinal direction, wherein a ninth pocket 406a is formed in an inner face of the extension 406 and is adjacent to a left edge of the longitudinal cover sheet extension 406, wherein a tenth pocket 406b is formed in the inner face of the extension 406 and is adjacent to a right edge of the extension 406; a first stack of one-side-bound inner paper sheets 408, wherein a first sheet 408a and a last sheet 408b of the first stack of one-side-bound inner paper sheets 408 are removably inserted into the first pocket 402a and the second pocket 402b, respectively, wherein the first stack has first writable paper sheets 408c disposed between the first and last sheets 408a and 408b; a second stack of one-side-bound inner paper sheets 410, wherein a first sheet 410a of the second stack of one-side-bound inner paper sheets 410 is removably inserted into the sixth pocket 402f, or a last sheet 410b of the second stack of one-side-bound inner paper sheets 410 is removably inserted into the fourth pocket 402d, wherein the second stack has second writable paper sheets 410c disposed between the first and last sheets 410a and 410b of the second stack of one-side-bound inner paper sheets 410; a third stack of one-side-bound inner paper sheets 412, wherein a last sheet 412b of the third stack of one-side-bound inner paper sheets 412 is removably inserted into the eighth pocket 404b, or a first sheet 412a of the third stack of one-side-bound inner paper sheets 412 is removably inserted into the seventh pocket 404a, wherein the third stack has third writable paper sheets 412c disposed between the first and last sheets 412a and 412b of the third stack of one-side-bound inner paper sheets 412; and a fourth stack of one-side-bound inner paper sheets 414, wherein a last sheet 414b of the fourth stack of one-side-bound inner paper sheets 414 is removably inserted into the ninth pocket 406a, or a first sheet 414a of the fourth stack of one-side-bound inner paper sheets 414 is removably inserted into the tenth pocket 406b, wherein the fourth stack has fourth writable paper sheets 414c disposed between the first and last sheets 414a and 414b of the fourth stack of one-side-bound inner paper sheets 414, wherein each of the first, second, third, and fourth stacks is embodied as a blank paper sheets stack or an underlined paper sheets stack or a printed book having content printed thereon.

According to the present disclosure, the user can freely change the position of the stack of one-side-bound inner paper sheets, and thus can make notes or handwriting in a convenient way. When the stack of one-side-bound inner paper sheets are completely used, the stack may be replaced with a new stack of one-side-bound inner paper sheets, which can save money and waste material.

### BRIEF DESCRIPTION OF THE DRAWINGS

FIG. 1 and FIG. 2 are perspective views showing the structure of a multi-stage notebook system according to the related art.

FIG. 3 is a perspective view illustrating the structure of the notebook system according to the first embodiment.

FIG. 4 is a perspective view showing the internal structure of the notebook system of FIG. 3.

FIG. 5 is an exploded perspective view showing a state in which stacks of one-side bound inner paper sheets are separated from the outermost cover sheet.

FIG. 6 is a cross-sectional view of the notebook system in a configuration that stacks of one-side-bound inner paper sheets are partially inserted in an outward direction of the outermost cover sheet.

FIG. 7 is a cross-sectional view of the notebook system in a configuration that stacks of one-side-bound inner paper sheets are partially inserted in an inward direction of the outermost cover sheet.

FIG. 8 to FIG. 10 are perspective views illustrating positions of pockets according to other embodiments.

FIG. 11 is a perspective view illustrating the structure of the notebook system according to the second embodiment;

FIG. 12 shows a state in which a transverse cover sheet is unfolded in the notebook system of FIG. 11.

FIG. 13 is an exploded perspective view showing the second stack of one-side-bound inner paper sheets separated from the outermost cover sheet.

FIG. 14 shows a state in which the outermost cover sheet and the transverse cover sheet are unfolded in the notebook system of FIG. 11.

FIG. 15 is an exploded perspective view showing a state where a first stack of one-side-bound inner paper sheets is separated from the outermost cover sheet.

FIG. 16 illustrates a state in which a first stack of one-side-bound inner paper sheets is partially inserted into the pocket formed on the inner face of the outermost cover sheet and a second stack of one-side-bound inner paper sheets is partially inserted into the pocket formed on the outer face of the outermost cover sheet.

FIG. 17 illustrates a state in which the second stack of one-side-bound inner paper sheets is inserted into a pocket formed on the outer face of the outermost cover sheet.

FIG. 18 is a perspective view illustrating the structure of the notebook system according to the third embodiment.

FIG. 19 is a perspective view showing the internal structure of the notebook system of FIG. 18 when the sheet extension is folded.

FIG. 20 is a perspective view showing the internal structure of the notebook system of FIG. 18 when the sheet extension is unfolded.

FIG. 21 is an exploded perspective view showing a state in which stacks of one-side bound inner paper sheets are separated from the outermost cover sheet and the sheet extension.

FIG. 22 is a cross-sectional view of the notebook system in a configuration that stacks of one-side-bound inner paper sheets are partially inserted in an outward direction of the outermost cover sheet.

FIG. 23 is a cross-sectional view of the notebook system in a configuration that stacks of one-side-bound inner paper sheets are partially inserted in an inward direction of the outermost cover sheet.

FIG. 24 to FIG. 26 are perspective views illustrating positions of pockets according to other embodiments.

FIG. 27 is a perspective view illustrating the structure of the notebook system according to the fourth embodiment.

FIG. 28 is a perspective view showing the internal structure of the notebook system of FIG. 27 when the sheet extensions are folded.

FIG. 29 is a perspective view showing the internal structure of the notebook system of FIG. 27 when the sheet extensions are unfolded.

FIG. 30 is an exploded perspective view showing a state in which stacks of one-side bound inner paper sheets are separated from the outermost cover sheet and the sheet extensions.

FIG. 31 is a cross-sectional view of the notebook system in a configuration that stacks of one-side-bound inner paper sheets are partially inserted in an outward direction of the outermost cover sheet.

FIG. 32 is a cross-sectional view of the notebook system in a configuration that stacks of one-side-bound inner paper sheets are partially inserted in an inward direction of the outermost cover sheet.

FIG. 33 to FIG. 35 are perspective views illustrating positions of pockets according to other embodiments.

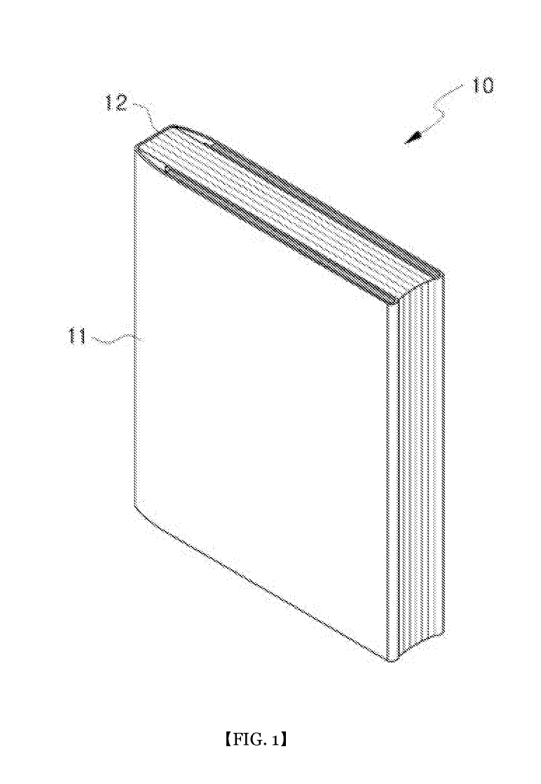

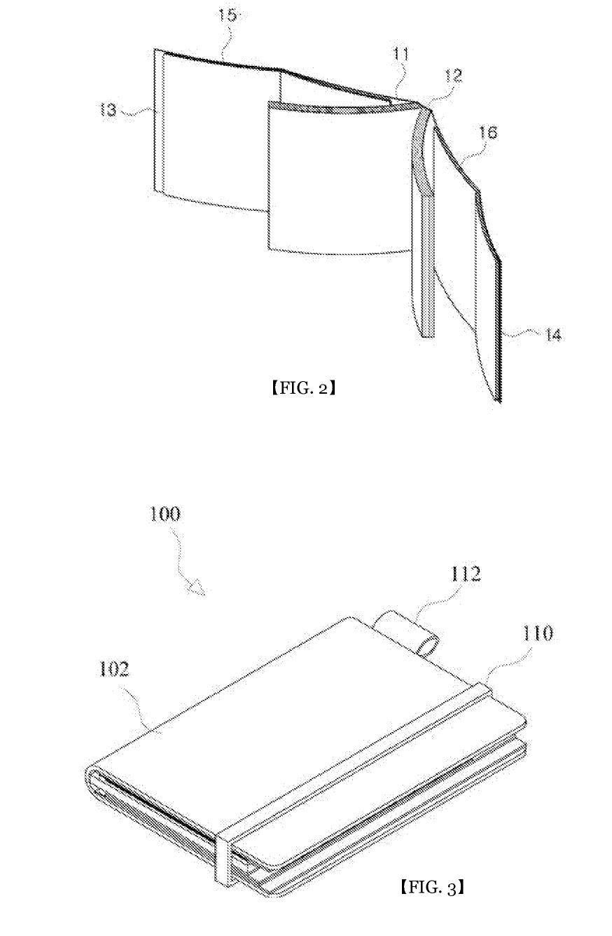

### DETAILED DESCRIPTIONS

Hereinafter, the notebook system (hereinafter, referred to as the notebook system) capable of replacing a stack of one-side-bound inner paper sheets according to an embodiment of the present disclosure will be described with reference to the drawings.

### First Embodiment

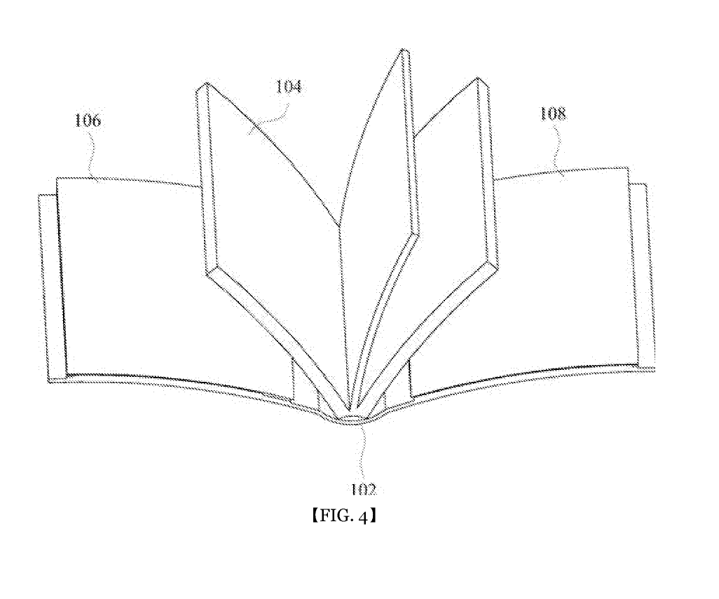

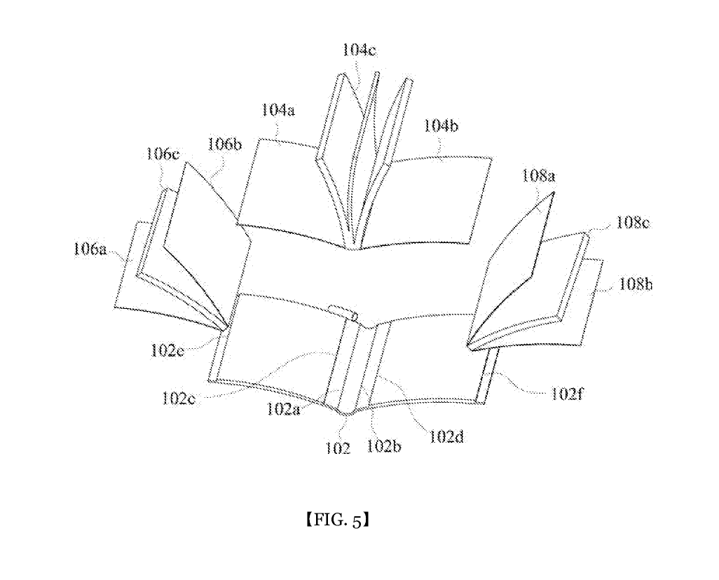

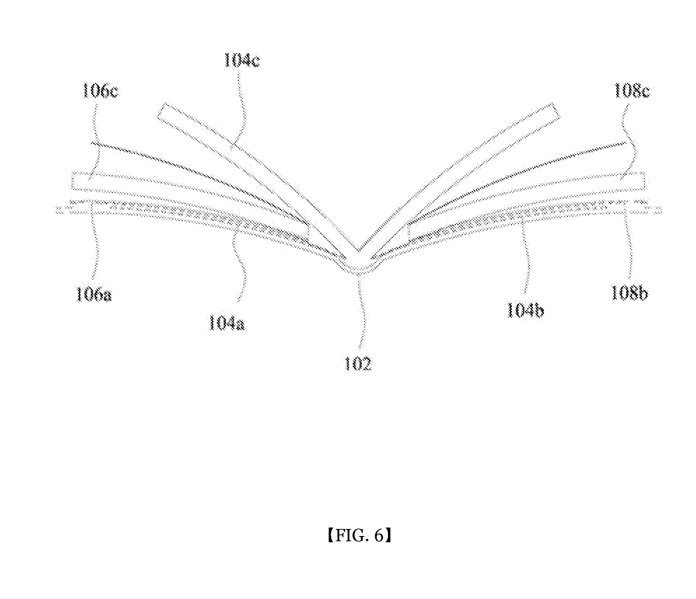

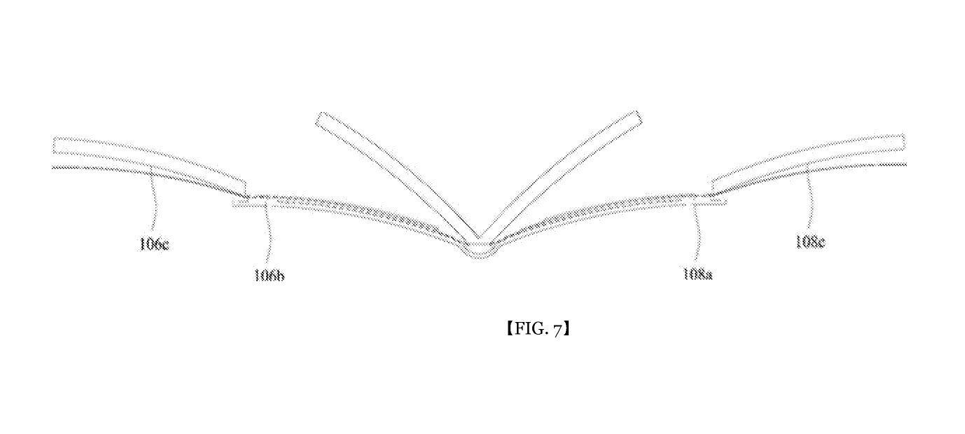

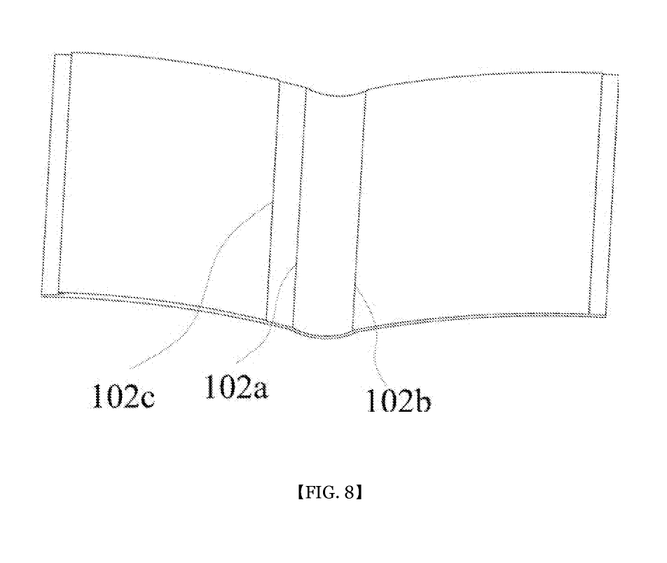

FIG. 3 is a perspective view illustrating the structure of the notebook system according to the first embodiment. FIG. 4 is a perspective view showing the internal structure of the notebook system of FIG. 3. FIG. 5 is an exploded perspective view showing a state in which stacks of one-side bound inner paper sheets are separated from the outermost cover sheet. FIG. 6 is a cross-sectional view of the notebook system in a configuration that stacks of one-side-bound inner paper sheets are partially inserted in an outward direction of the outermost cover sheet. FIG. 7 is a cross-sectional view of the notebook system in a configuration that stacks of one-side-bound inner paper sheets are partially inserted in an inward direction of the outermost cover sheet. FIG. 8 to FIG. 10 are perspective views illustrating positions of pockets according to other embodiments.

The notebook system 100 according to the first embodiment has a structure in which a plurality of stacks of one-sided-bound inner paper sheets are embedded in a single outermost cover sheet 102 foldable with respect to a center line thereof, similar to a conventional notebook.

The outermost cover sheet 102, which forms the appearance of the notebook system, is made of paper, vinyl, leather, fabric, or synthetic leather, as in a typical configuration. The first stack of one-side bound inner paper sheets 104 are embedded in and coupled to the outermost cover sheet 102 such that, when the outermost cover sheet 102 is folded or unfolded with respect to its centerline, the first stack of one-side bound inner paper sheets 104 folds or unfolds in the same direction as the folding or unfolding direction of the outermost cover sheet 102. That is, the bound portion of the first stack of one-side-bound inner paper sheets 104 is in contact with the inner face at the center line of the outermost cover sheet 102.

Further, a second stack of one-side bound inner paper sheets 106 and a third stack of one-side-bound inner paper sheets 108 are placed respectively between the left and right inner faces of the outermost cover sheet 102 and the leftmost and rightmost sheets of the first stack of one-side-bound inner paper sheets 104.

For convenience of illustration, when the notebook system 100 is unfolded, a stack disposed in the center of the cover sheet may be the first stack of one-side bound inner paper sheets 104, and a stack disposed on the left inner side of the cover sheet may be the second stack of one-side-bound inner paper sheets 106, and a stack disposed on the right inner side of the sheet may be a third stack of one-side-bound inner paper sheets 108.

In accordance with the present disclosure, each of the first stack of one-side-bound inner paper sheets 104, the second stack of one-side-bound inner paper sheets 106, and the third stack of one-side-bound inner paper sheets 108 may be embodied as a blank paper sheets stack or underlined paper sheets stack or a printed book having content printed thereon. Alternatively, the first stack of one-side-bound inner paper sheets 104, the second stack of one-side-bound inner paper sheets 106, and the third stack of one-side-bound inner paper sheets 108 may be embodied in different formats including a blank paper sheets stack and underlined paper sheets stack and a printed book having content printed thereon.

When not using the notebook 100 of the present disclosure, the outermost cover sheet 102 is folded. An unfolding-prevention band no covering the outside face of the outermost cover sheet 102 may prevent the outermost cover sheet 102 in a folded state from being unfolded. The unfolding-prevention band no may be formed of an elastic material and may be configured to simultaneously enclose the front and back faces of the outermost cover sheet 102.

A pen holder 112 for receiving a writing instrument including a ballpoint pen or pencil is attached to one edge of the outermost cover sheet 102.

When the outermost cover sheet 102 is unfolded as shown in FIG. 4, the first stack of one-side-bound inner paper sheets 104, the second stack of one-side-bound inner paper sheets 106 and the third stack of one-side-bound inner paper sheets 108 may be exposed. The second stack of one-side-bound inner paper sheets 106 may be disposed between a front sheet portion of the outermost cover sheet 102 and the first stack of one-side-bound inner paper sheets 104. The third stack of one-side-bound inner paper sheets 108 may be disposed between a rear sheet portion of the outermost cover sheet 102 and the first stack of one-side-bound inner paper sheets 104.

Several pockets are formed in the inner face or at a lateral edge of the outermost cover sheet 102. The pockets may be formed by cutting the inner face portion of the outermost cover sheet 102 or by attaching a further sheet to the outermost cover sheet 102.

A first pocket 102a and a second pocket 102b are formed adjacent to and to the left and right sides of the central folding line of the outermost cover sheet 102, respectively. A third pocket 102c and a fourth pocket 102d are formed on the left side of the first pocket 102a and the right side of the second pocket 102b, respectively. A fifth pocket 102e and a sixth pocket 102f are formed on the left and right sides of the third pocket 102c and the fourth pocket 102d, respectively. The first pocket 102a to the fourth pocket 102d are formed adjacent to the central folding line of the outermost cover sheet 102, while the fifth pocket 102e and the second pocket 102f are formed adjacent to the left and right edges of the outermost cover sheet 102, respectively.

Further, a first sheet 104a and a last sheet 104b of the first stack of one-side-bound inner paper sheets 104 are inserted into the first pocket 102a and the second pocket 102b, respectively. First writable paper sheets 104c between the first and last sheets 104a and 104b are unfolded left and right around the central folding line of the outermost cover sheet 102.

Further, a first sheet 106a of the second stack of one-side-bound inner paper sheets 106 is inserted into the third pocket 102c, while a last sheet 108b of the third stack of one-side bound inner paper sheets 108 is inserted into the fourth pocket 102d. Thus, second writable paper sheets 106c located between the first and last sheets 106a and 106b of the second stack of one-side-bound inner paper sheets 106 are disposed on the left side of the first writable paper sheets 104c, while third writable paper sheets 108c located between the first and last sheets 108a and 108b of the third stack of one-side-bound inner paper sheets 108 are disposed on the right side of the first writable paper sheets 104c. Because the bound portion of each of the first writable paper sheets 104c, the second writable paper sheets 106c, and the third writable paper sheets 108c is located adjacent to the central folding line of the outermost cover sheet 102, the first writable paper sheets 104c, the second writable paper sheets 106c, and the third writable paper sheets 108c are unfolded in the same direction. In this case, as shown in FIG. 6, the first writable paper sheets 104c, the second writable paper sheets 106c, and the third writable paper sheets 108c may overlap with each other. Therefore, all of the first writable paper sheets 104c, the second writable paper sheets 106c, and the third writable paper sheets 108c may not be used at the same time. That is, only one of the first writable paper sheets 104c, the second writable paper sheets 106c, and the third writable paper sheets 108c may be used at a time.

Alternatively, in order that all of the first writable paper sheets 104c, the second writable paper sheets 106c, and the third writable paper sheets 108c are used at the same time, pockets to receive the second writable paper sheets 106c, and the third writable paper sheets 108c may be changed.

Specifically, referring to FIG. 7, pockets to receive the second writable paper sheets 106c, and the third writable paper sheets 108c may be changed. That is, the last sheet 106b of the second stack of one-side-bound inner paper sheets 106 is inserted into the left edge-adjacent fifth pocket 102e of the outermost cover sheet 102, while the first sheet 108a of the third stack of one-side bound inner paper sheets 108 is inserted into the right edge-adjacent sixth pocket 102f of the outermost cover sheet 102.

In this case, the second writable paper sheets 106c of the second stack of one-side-bound inner paper sheets 106 are unfolded to the left of the first stack of one-side-bound inner paper sheets 104, while the third writable paper sheets 108c of the third stack of one-side bound inner paper sheets 108 are unfolded to the right side of the first stack of one-side bound inner paper sheets 104. This allows at least four sheet faces to be used simultaneously.

In this way, by changing the pockets to accommodate the first stack of one-side bound inner paper sheets 104, the second stack of one-side bound inner paper sheets 106, and the third stack of one-side bound inner paper sheets 108, the user may use writable paper sheets in their desired locations.

FIGS. 8 to 10 are perspective views showing positions of the pocket according to other embodiments.

Although the first stack of one-side bound inner paper sheets 104, the second stack of one-side bound inner paper sheets 106, and the third stack of one-side bound inner paper sheets 108 may be inserted into respective separate pockets, the present invention is not limited to this. At least two of the first stack of one-side bound inner paper sheets 104, the second stack of one-side bound inner paper sheets 106, and the third stack of one-side bound inner paper sheets 108 may be inserted into one pocket.

As shown in FIG. 8, the fourth pocket 102d is removed, and the first stack of one-side bound inner paper sheets 104 and the third stack of one-side bound inner paper sheets 108 may be inserted together in the second pocket 102b.

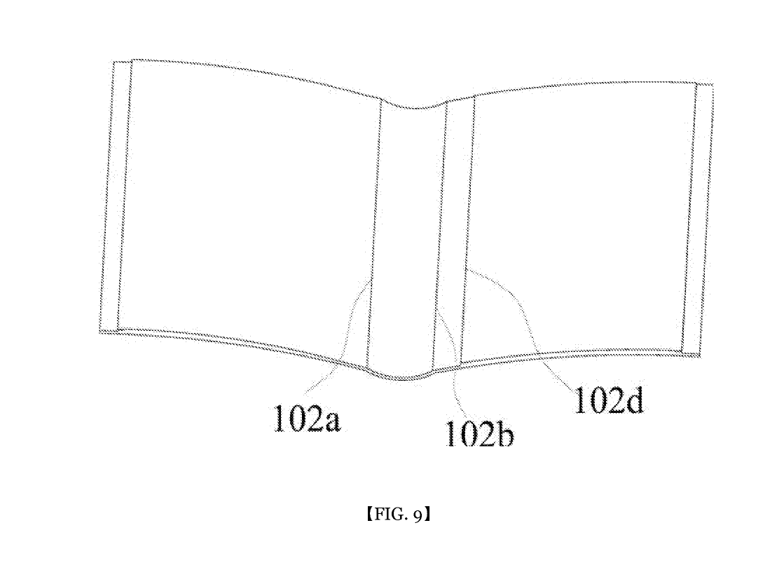

Further, as shown in FIG. 9, the third pocket 102c is removed, and the first stack of one-side bound inner paper sheets 104 and the second stack of one-side bound inner paper sheets 106 may be inserted into the first pocket 102a together.

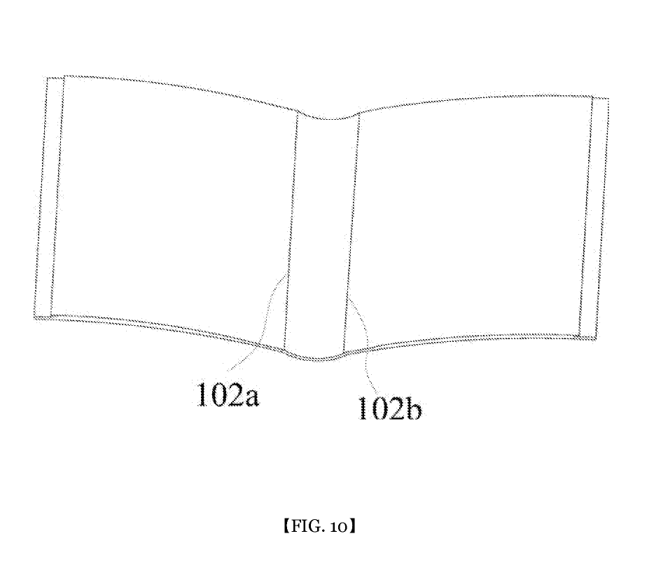

Further, as shown in FIG. 10, the third pocket 102c and the fourth pocket 102d are all removed. In this connection, the first stack of one-side bound inner paper sheets 104 and the second stack of one-side bound inner paper sheets 106 are inserted together into the first pocket 102a, while the first stack of one-side bound inner paper sheets 104 and the third stack of one-side bound inner paper sheets 108 may be inserted together in the second pocket 102b.

### Second Embodiment

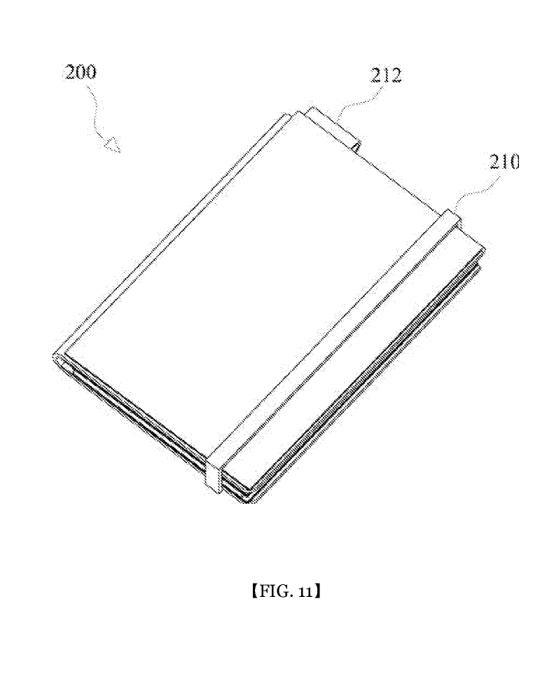

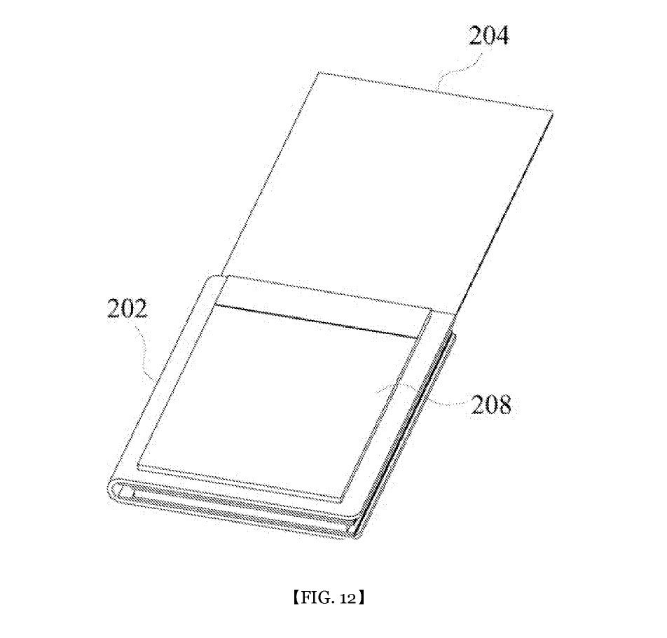

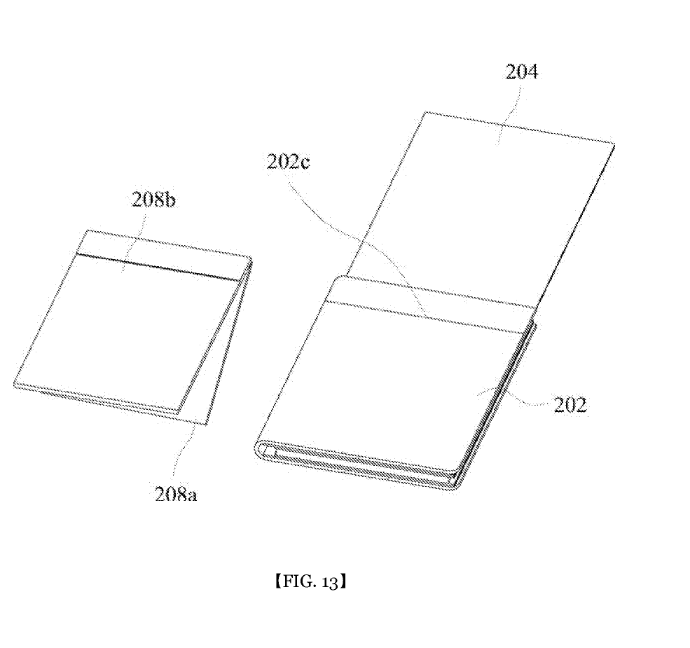

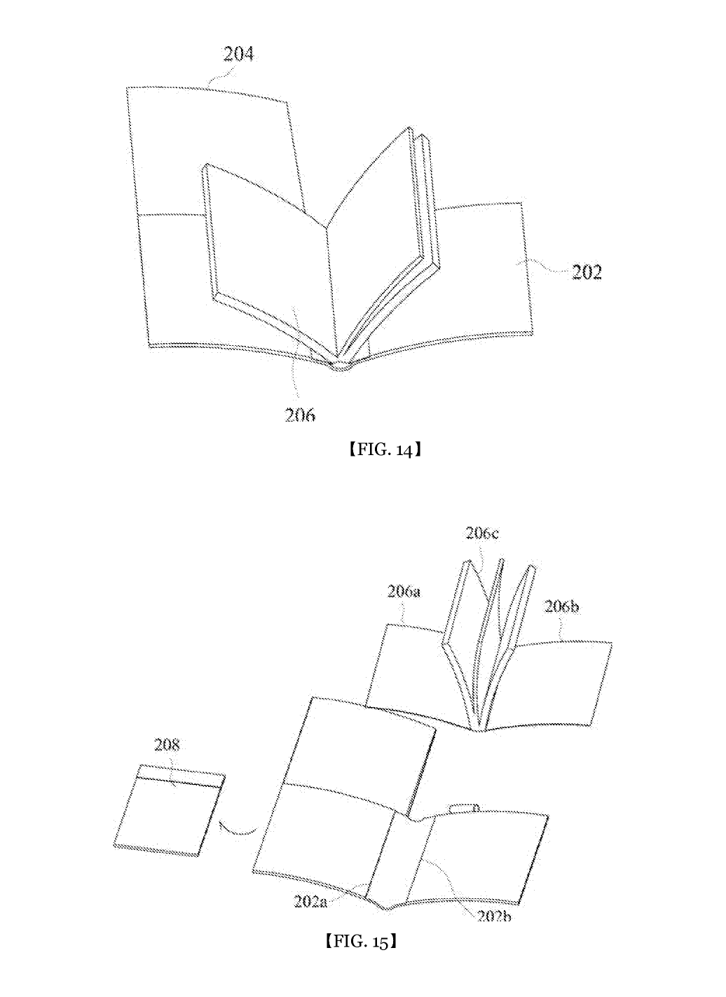

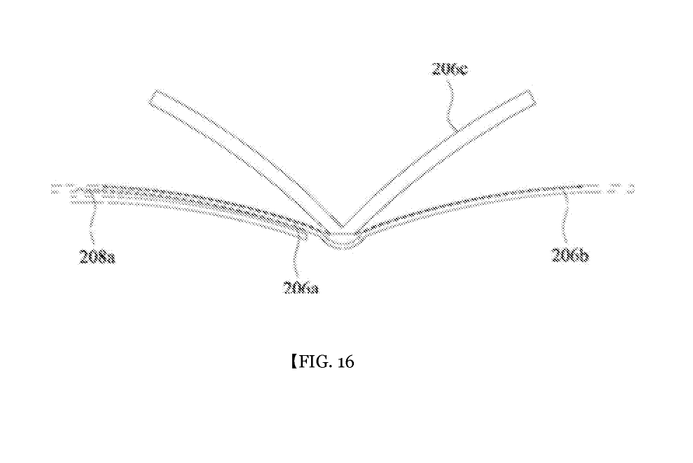

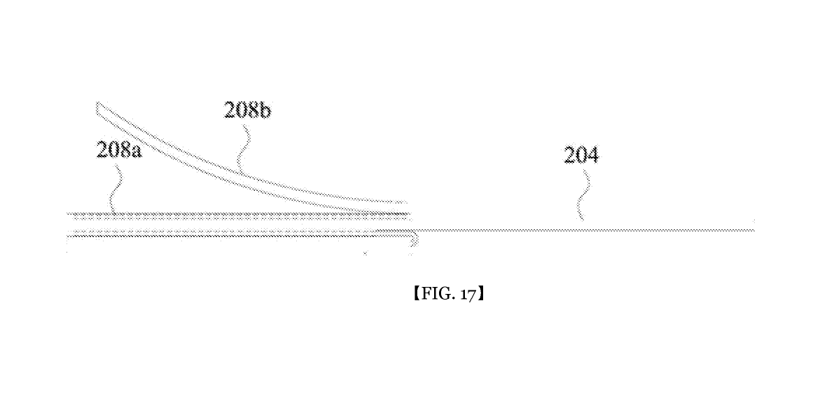

FIG. 11 is a perspective view illustrating the structure of the notebook system according to the second embodiment. FIG. 12 shows a state in which a transverse cover sheet is unfolded in the notebook system of FIG. 11. FIG. 13 is an exploded perspective view showing the second stack of one-side-bound inner paper sheets separated from the outermost cover sheet. FIG. 14 shows a state in which the outermost cover sheet and the transverse cover sheet are unfolded in the notebook system of FIG. 11. FIG. 15 is an exploded perspective view showing a state where a first stack of one-side-bound inner paper sheets is separated from the outermost cover sheet. FIG. 16 illustrates a state in which a first stack of one-side-bound inner paper sheets is partially inserted into the pocket formed on the inner face of the outermost cover sheet and a second stack of one-side-bound inner paper sheets is partially inserted into the pocket formed on the outer face of the outermost cover sheet. FIG. 17 illustrates a state in which the second stack of one-side-bound inner paper sheets is inserted into a pocket formed on the outer face of the outermost cover sheet.

The notebook system 200 according to the second embodiment has a structure in which a plurality of stacks of one-sided-bound inner paper sheets are embedded in a single outermost cover sheet 202 foldable with respect to a center line thereof, similar to a conventional notebook, and an transverse sheet extension 204 is further foldably coupled to the single outermost cover sheet 202. The transverse sheet extension 204 may be coupled to on the outer face of the front sheet portion or the rear sheet portion of the outermost cover sheet 202 to be folded or unfolded in the transverse direction. Generally, the transverse sheet extension 204 may be coupled to the outer face of the front sheet portion to be folded or unfolded in the transverse direction. To this end, a top or bottom edge of the transverse sheet extension 204 may be coupled to a bottom or top edge of the outermost cover sheet 202.

The outermost cover sheet 202, which forms the appearance of the notebook system, is made of paper, vinyl, leather, fabric, or synthetic leather, as in a typical configuration. The first stack of one-side bound inner paper sheets 206 are embedded in and coupled to the outermost cover sheet 202 such that, when the outermost cover sheet 202 is folded or unfolded with respect to its centerline, the first stack of one-side bound inner paper sheets 206 folds or unfolds in the same direction as the folding or unfolding direction of the outermost cover sheet 202. That is, the bound portion of the first stack of one-side-bound inner paper sheets 206 is in contact with the inner face at the center line of the outermost cover sheet 102.

Several pockets are formed in the inner face of the outermost cover sheet 202. The pockets may be formed by cutting the inner face portion of the outermost cover sheet 202 or by attaching a further sheet to the outermost cover sheet 202 as in the first embodiment. A first pocket 202a and a second pocket 202b are formed adjacent to and to the left and right sides of the central folding line of the outermost cover sheet 202, respectively. Further, a first sheet 206a and a last sheet 206b of the first stack of one-side-bound inner paper sheets 206 are inserted into the first pocket 202a and the second pocket 202b, respectively. First writable paper sheets 206c between the first and last sheets 206a and 206b are unfolded left and right around the central folding line of the outermost cover sheet 202.

The transverse sheet extension 204 is connected to the front sheet portion of the notebook system 200. Between the transverse sheet extension 204 and the outermost cover sheet 202, a second stack of one-side-bound inner paper sheets 208 may be fitted.

In accordance with the second embodiment, each of the first stack of one-side-bound inner paper sheets 206 and the second stack of one-side-bound inner paper sheets 208 may be embodied as a blank paper sheets stack or underlined paper sheets stack or a printed book having content printed thereon. Alternatively, the first stack of one-side-bound inner paper sheets 206 and the second stack of one-side-bound inner paper sheets 208 may be embodied in different formats including a blank paper sheets stack and underlined paper sheets stack and a printed book having content printed thereon.

When not using the notebook 200 of the present disclosure, the outermost cover sheet 202 is folded and the transverse sheet extension 204 is folded in an overlapping manner with the outermost cover sheet 202. Further, an unfolding-prevention band 210 covering the outer faces of the outermost cover sheet 202 and the transverse sheet extension 204 may be provided to prevent the outermost cover sheet 202 and the transverse sheet extension 204 from being unfolded. The unfolding-prevention band 210 may be formed of an elastic material and may be configured to simultaneously enclose the back face of the outermost cover sheet 202 and the front face of the transverse sheet extension 204.

A pen holder 212 for receiving a writing instrument including a ballpoint pen or pencil is attached to one edge of the outermost cover sheet 202.

Referring to FIG. 12, when the transverse sheet extension 204 connected to the upper end of the front portion of the outermost cover sheet 202 is unfolded in the transverse direction, the second stack of one-side-bound inner paper sheets 208 inserted into the outer face of the front portion of the outermost cover sheet 202 is exposed outwardly. The second stack of one-side-bound inner paper sheets 208 is partially inserted into a third pocket 202c formed in the outer face of the front portion of the outermost cover sheet 202. To be specific, a last paper sheet 208a of the second stack of one-side-bound inner paper sheets 208 is inserted into the third pocket 202c. As a result, the second writable paper sheets 208b are exposed to the outside.

Further, when the outermost cover sheet 202 is unfolded in the longitudinal direction, as shown in FIG. 14, the first stack of one-side-bound inner paper sheets 206 embedded in the outermost cover sheet 202 is revealed. The first sheet 206a and last sheet 206b of the first stack of one-side-bound inner paper sheets 206 are inserted into the first pocket 202a and the second pocket 202b, respectively. The first writable paper sheets 206c between the first and last sheets 206a and 206b are unfolded left and right around the central folding line of the outermost cover sheet 202.

### Third Embodiment

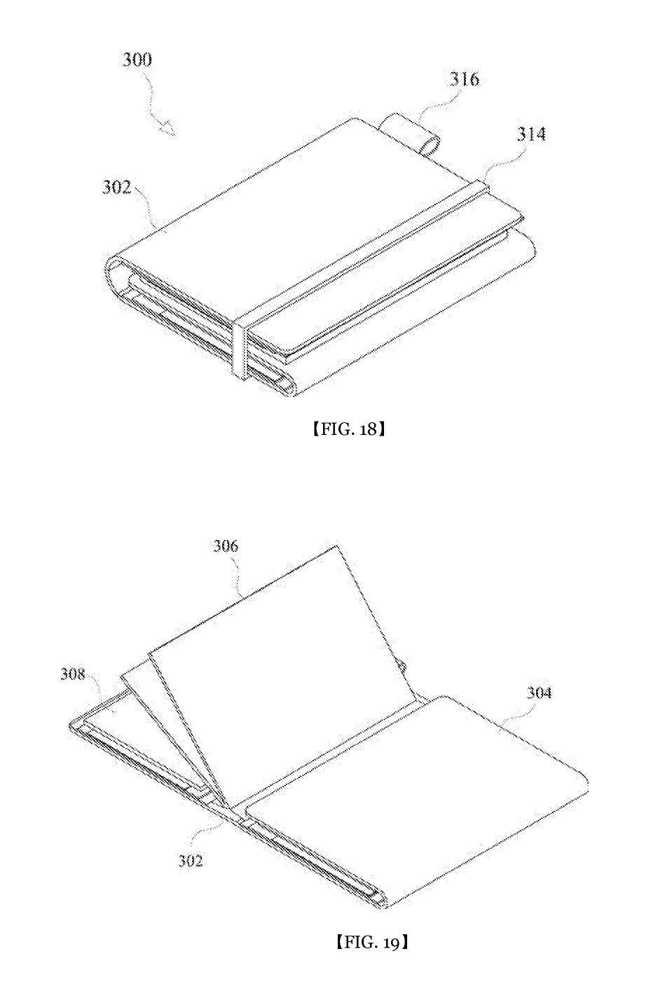

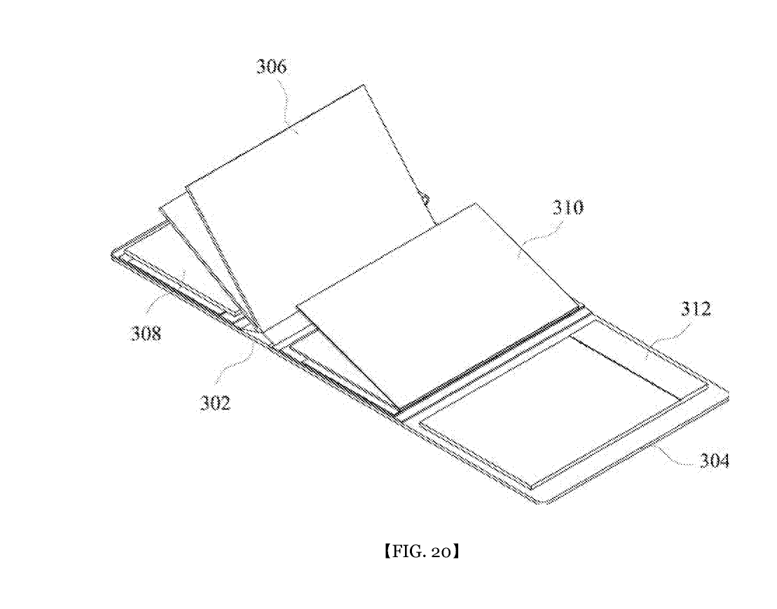

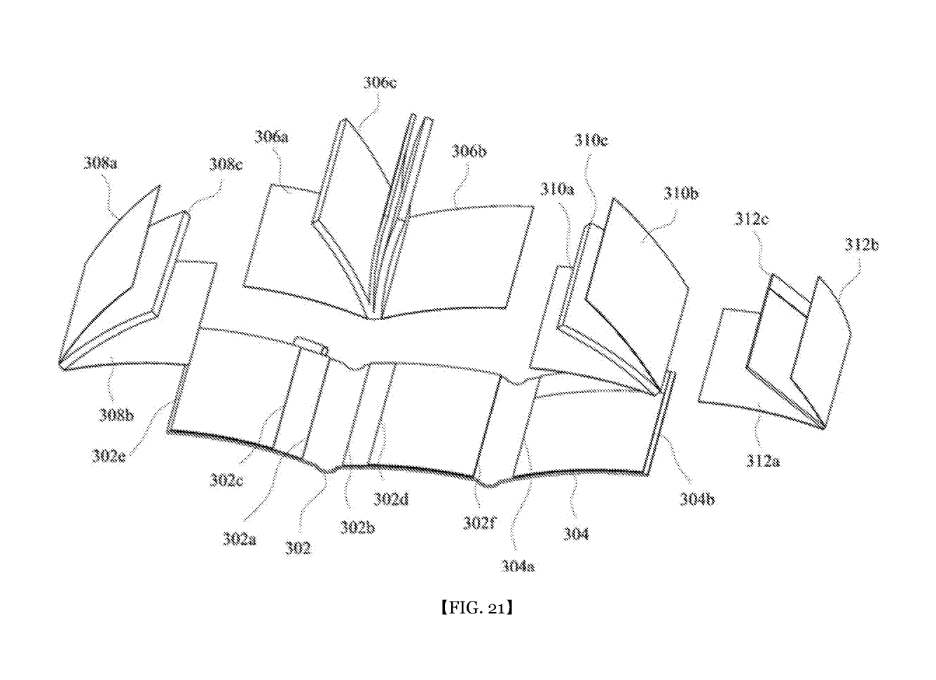

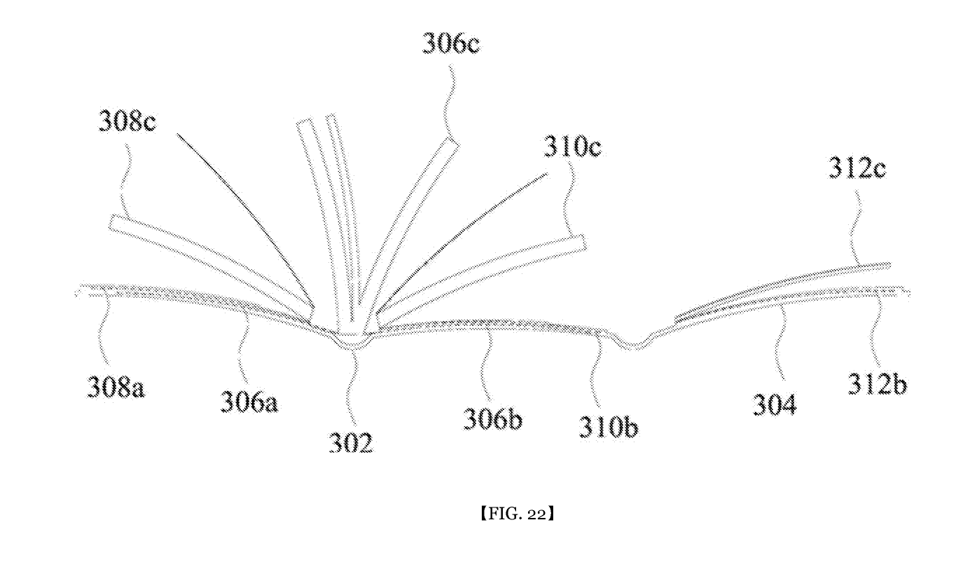

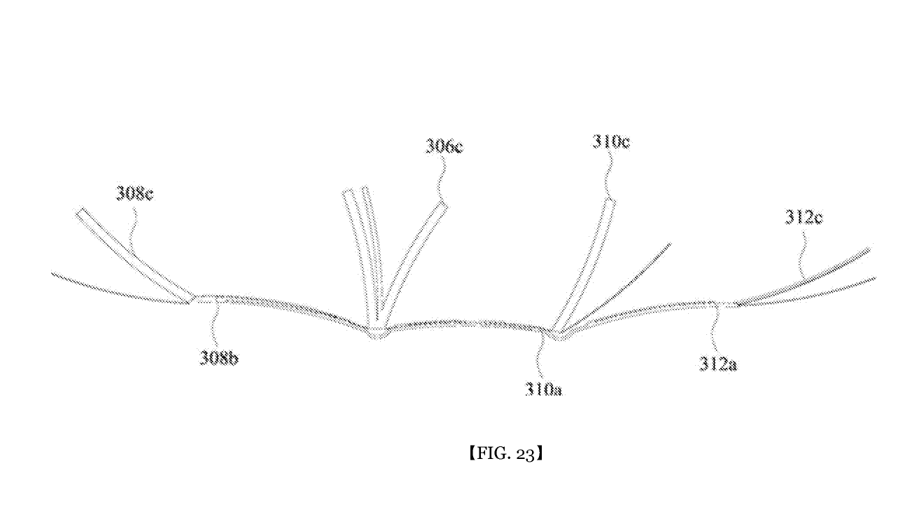

FIG. 18 is a perspective view illustrating the structure of the notebook system according to the third embodiment. FIG. 19 is a perspective view showing the internal structure of the notebook system of FIG. 18 when the sheet extension is folded. FIG. 20 is a perspective view showing the internal structure of the notebook system of FIG. 18 when the sheet extension is unfolded. FIG. 21 is an exploded perspective view showing a state in which stacks of one-side bound inner paper sheets are separated from the outermost cover sheet and the sheet extension. FIG. 22 is a cross-sectional view of the notebook system in a configuration that stacks of one-side-bound inner paper sheets are partially inserted in an outward direction of the outermost cover sheet. FIG. 23 is a cross-sectional view of the notebook system in a configuration that stacks of one-side-bound inner paper sheets are partially inserted in an inward direction of the outermost cover sheet.

The notebook system 30o according to the third embodiment has a structure in which a plurality of stacks of one-sided-bound inner paper sheets are embedded in a single outermost cover sheet 302 foldable with respect to a center line thereof, as in the first embodiment and a longitudinal cover sheet extension 304 is coupled to the outermost cover sheet 302. The longitudinal cover sheet extension 304 is unfolded in the longitudinal direction, leftward or rightward direction in the same manner as the main outermost cover sheet 302. Thus, when both the main outermost cover sheet 302 and the longitudinal cover sheet extension 304 are unfolded, the front, middle and rear inner faces are unfolded as shown in FIG. 20.

In the drawings of the present disclosure, the longitudinal cover sheet extension 304 is shown connected to the right edge of the main outermost cover sheet 302, but the present invention is not limited thereto. Rather, the longitudinal cover sheet extension 304 may be connected to the left edge of the main outermost cover sheet 302.

The first stack of one-side bound inner paper sheets 306 are embedded in and coupled to the outermost cover sheet 302 such that, when the outermost cover sheet 302 is folded or unfolded with respect to its centerline, the first stack of one-side bound inner paper sheets 306 folds or unfolds in the same direction as the folding or unfolding direction of the outermost cover sheet 302. Further, a second stack of one-side bound inner paper sheets 308 and a third stack of one-side-bound inner paper sheets 310 are placed respectively between the left and right inner faces of the outermost cover sheet 302 and the leftmost and rightmost sheets of the first stack of one-side-bound inner paper sheets 306. Further, a fourth stack of one-side-bound inner paper sheets 312 is partially inserted in the longitudinal cover sheet extension 304. Thus, all of the first stack of one-side-bound inner paper sheets 306, the second stack of one-side-bound inner paper sheets 308, the third stack of one-side-bound inner paper sheets 310 and the fourth stack of one-side-bound inner paper sheets 312 may be partially inserted into the pockets in the inner faces of the two outermost cover sheets 302 and 312.

Several pockets are formed in the inner face of the outermost cover sheet 302. The pockets may be formed by cutting the inner face portion of the outermost cover sheet 302 or by attaching a further sheet to the outermost cover sheet 302. A first pocket 302a and a second pocket 302b are formed adjacent to and to the left and right sides of the central folding line of the outermost cover sheet 302, respectively. A third pocket 302c and a fourth pocket 302d are formed on the left side of the first pocket 302a and the right side of the second pocket 302b, respectively.

A fifth pocket 302e and a sixth pocket 302f are formed on the left and right sides of the third pocket 302c and the fourth pocket 302d and adjacent to the left and right edges of the outermost cover sheet 302 respectively.

In the longitudinal cover sheet extension 304, a seventh pocket 304a is formed adjacent to the left edge of the longitudinal cover sheet extension 304, while an eighth pocket 304b is formed adjacent to the right edge of the extension 304. The left edge of the longitudinal cover sheet extension 304 is, by way of example, connected to the right edge of the main outermost cover sheet 302 according to this embodiment.

In this third embodiment, the configuration, material, and coupling of the outermost cover sheet and the stacks of one-side-bound inner paper sheets and pockets are the same as in the previous embodiments.

When only the main outermost cover sheet 302 is unfolded, the user may use the first stack of one-side-bound inner paper sheets 306 and the second stack of one-side-bound inner paper sheets 308. When both the main outermost cover sheet 302 and the longitudinal cover sheet extension 304 are unfolded, the user may use any one of the first stack of one-side-bound inner paper sheets 306, the second stack of one-side-bound inner paper sheets 308, the third stack of one-side-bound inner paper sheets 310, and the fourth stack of one-side-bound inner paper sheets 312.

Further, a first sheet 306a and a last sheet 306b of the first stack of one-side-bound inner paper sheets 306 are inserted into the first pocket 302a and the second pocket 302b, respectively. First writable paper sheets 306c between the first and last sheets 306a and 306b are unfolded left and right around the central folding line of the outermost cover sheet 302. Further, a first sheet 308a of the second stack of one-side-bound inner paper sheets 308 is inserted into the third pocket 302c, while a last sheet 310b of the third stack of one-side bound inner paper sheets 310 is inserted into the fourth pocket 302d. Thus, second writable paper sheets 308c located between the first and last sheets 308a and 308b of the second stack of one-side-bound inner paper sheets 308 are disposed on the left side of the first writable paper sheets 306c, while third writable paper sheets 310c located between the first and last sheets 310a and 310b of the third stack of one-side-bound inner paper sheets 310 are disposed on the right side of the first writable paper sheets 306c. This is shown in FIG. 22. The last sheet 312b of the fourth stack of one-side-bound inner paper sheets 312 is inserted into the seventh pocket 304a.

When the last sheet 308b of the second stack of one-side-bound inner paper sheets 308 is inserted into the fifth pocket 302e, the first sheet 310a of the third stack of one-side-bound inner paper sheets 310 is inserted into the sixth pocket 302f, the first sheet 312a of the fourth stack of one-side-bound inner paper sheets 312 is inserted into the eighth pocket 304b, the configuration as shown in FIG. 23 may be achieved. That is, the degree of overlap between the stacks is minimized, so that multiple faces may be used at the same time.

When not using the notebook 300 of the present disclosure, the outermost cover sheet 302 and the extension 304 may be folded. An unfolding-prevention band 314 covering the outside face of the outermost cover sheet 302 may prevent the outermost cover sheet 302 in a folded state from being unfolded. The unfolding-prevention band 314 may be formed of an elastic material and may be configured to simultaneously enclose the front and back faces of the outermost cover sheet 302.

A pen holder 316 for receiving a writing instrument including a ballpoint pen or pencil is attached to one edge of the outermost cover sheet 302.

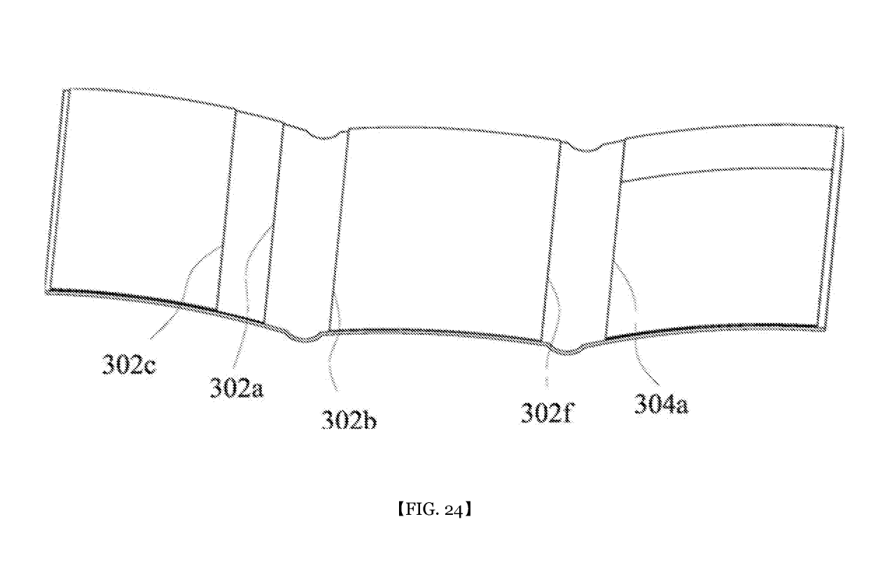

FIGS. 24 to 26 are perspective views showing positions of the pocket according to other embodiments.

Although the first stack of one-side bound inner paper sheets 306, the second stack of one-side bound inner paper sheets 308, and the third stack of one-side bound inner paper sheets 310 may be partially inserted into respective separate pockets, the present invention is not limited to this. At least two of the first stack of one-side bound inner paper sheets 306, the second stack of one-side bound inner paper sheets 308, and the third stack of one-side bound inner paper sheets 310 may be partially inserted into one pocket.

As shown in FIG. 24, the fourth pocket 302d is removed, and the first stack of one-side bound inner paper sheets 306 and the third stack of one-side bound inner paper sheets 310 may be partially inserted together in the second pocket 302b.

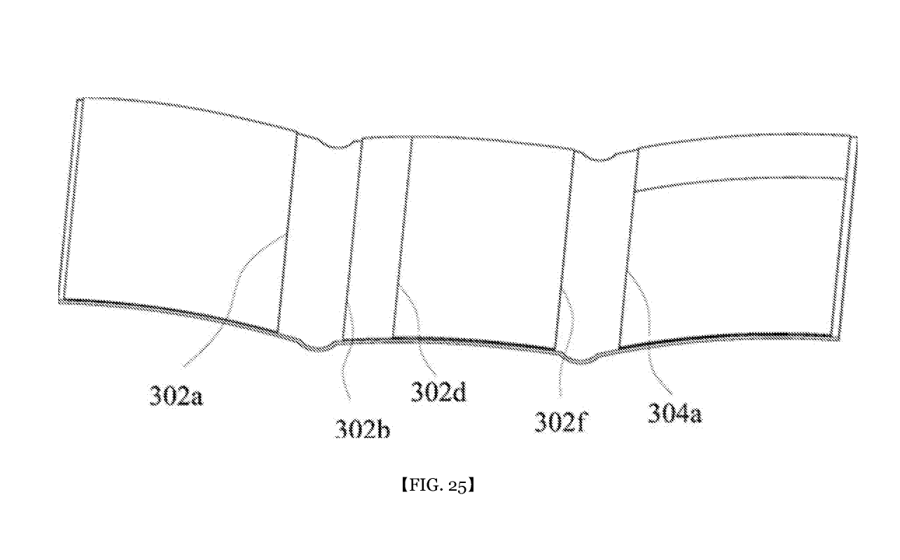

Further, as shown in FIG. 25, the third pocket 302c is removed, and the first stack of one-side bound inner paper sheets 306 and the second stack of one-side bound inner paper sheets 308 may be partially inserted into the first pocket 302a together.

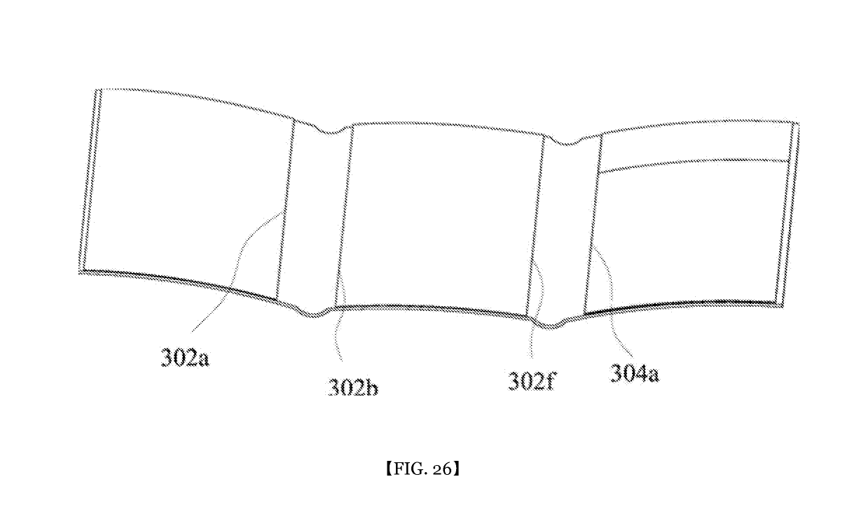

Further, as shown in FIG. 26, the third pocket 302c and the fourth pocket 302d are all removed. In this connection, the first stack of one-side bound inner paper sheets 306 and the second stack of one-side bound inner paper sheets 308 are partially inserted together into the first pocket 302a, while the first stack of one-side bound inner paper sheets 306 and the third stack of one-side bound inner paper sheets 310 may be partially inserted together in the second pocket 302b.

### Fourth Embodiment

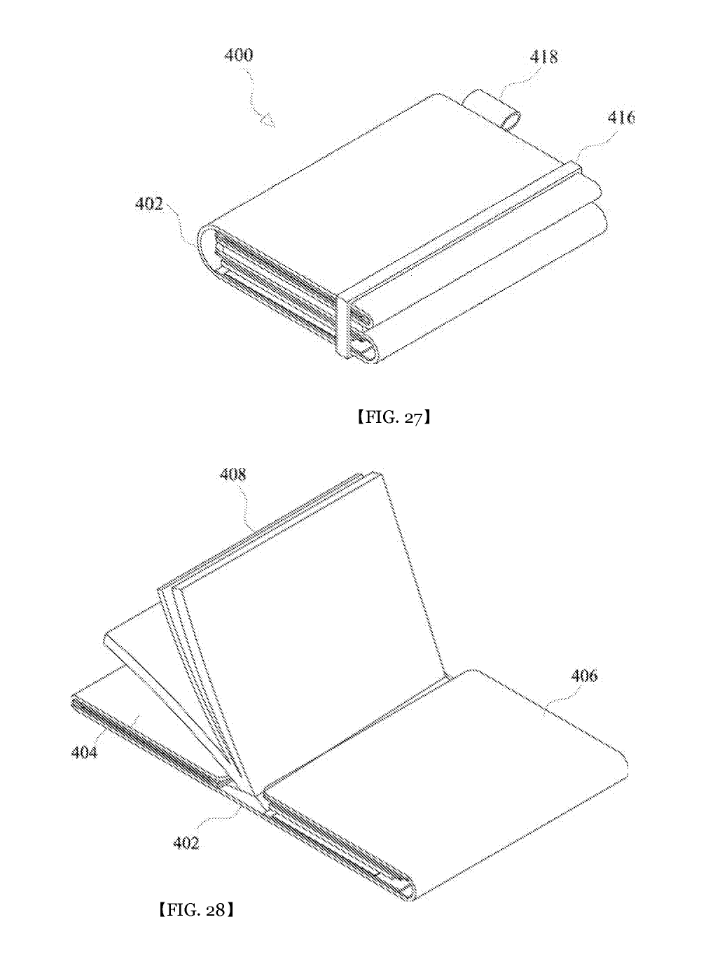

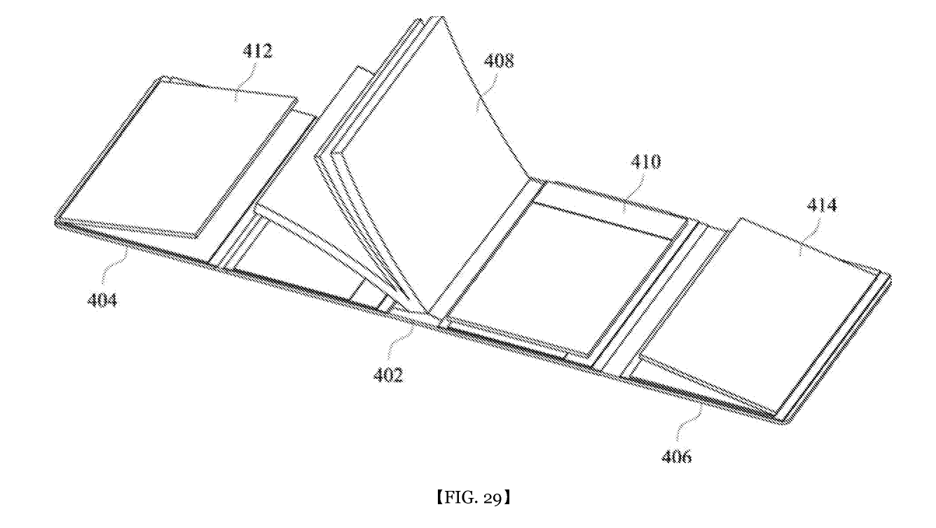

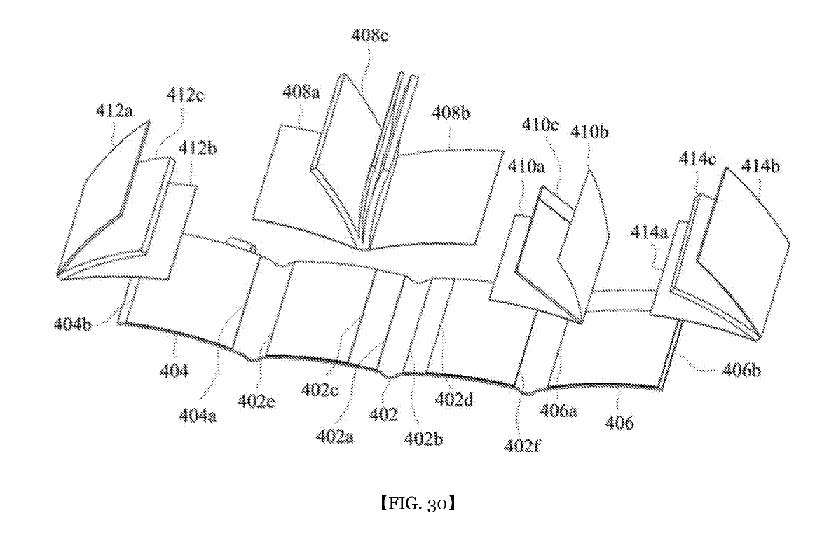

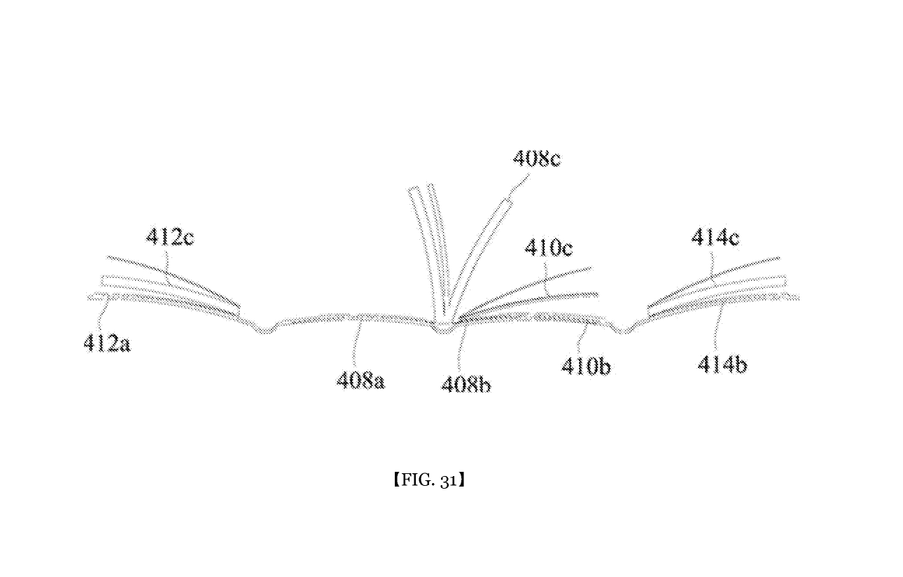

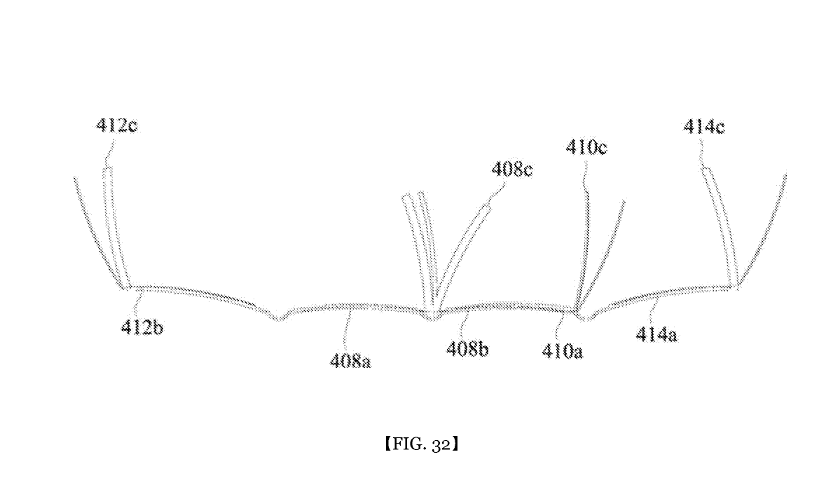

FIG. 27 is a perspective view illustrating the structure of the notebook system according to the fourth embodiment. FIG. 28 is a perspective view showing the internal structure of the notebook system of FIG. 27 when the sheet extensions are folded. FIG. 29 is a perspective view showing the internal structure of the notebook system of FIG. 27 when the sheet extensions are unfolded. FIG. 30 is an exploded perspective view showing a state in which stacks of one-side bound inner paper sheets are separated from the outermost cover sheet and the sheet extensions. FIG. 31 is a cross-sectional view of the notebook system in a configuration that stacks of one-side-bound inner paper sheets are partially inserted in an outward direction of the outermost cover sheet. FIG. 32 is a cross-sectional view of the notebook system in a configuration that stacks of one-side-bound inner paper sheets are partially inserted in an inward direction of the outermost cover sheet.

The notebook system 400 according to the fourth embodiment has a structure in which a plurality of stacks of one-sided-bound inner paper sheets are embedded in a single outermost cover sheet 402 foldable with respect to a center line thereof, as in the first embodiment and a longitudinal left cover sheet extension 404 is coupled to the left edge of the outermost cover sheet 402 and a longitudinal right cover sheet extension 406 is coupled to the right edge of the outermost cover sheet 402. The longitudinal cover sheet extensions 404 and 406 may be unfolded in the longitudinal direction, leftward or rightward direction in the same manner as the main outermost cover sheet 402. Thus, when both the main outermost cover sheet 402 and the longitudinal cover sheet extensions 404 and 406 are unfolded, the front, left-middle, right-middle and rear inner faces are unfolded as shown in FIG. 29.

The first stack of one-side bound inner paper sheets 408 are embedded in and coupled to the outermost cover sheet 402 such that, when the outermost cover sheet 402 is folded or unfolded with respect to its centerline, the first stack of one-side bound inner paper sheets 408 folds or unfolds in the same direction as the folding or unfolding direction of the outermost cover sheet 402. Further, a second stack of one-side bound inner paper sheets 410 and a third stack of one-side-bound inner paper sheets 412 are placed respectively between the left and right inner faces of the outermost cover sheet 402 and the leftmost and rightmost sheets of the first stack of one-side-bound inner paper sheets 408. Further, a third stack of one-side-bound inner paper sheets 412 is disposed on the left longitudinal sheet extension 404. A fourth stack of one-side-bound inner paper sheets 414 is disposed on the right longitudinal cover sheet extension 406. That is, the first stack of one-side-bound inner paper sheets 408 and the second stack of one-side-bound inner paper sheets 410 are joined to the main outermost cover sheet 402. The longitudinal cover sheet extension 404 and the longitudinal cover sheet extension 406 are combined with the third stack of one-side-bound inner paper sheets 412 and the fourth stack of one-side-bound inner paper sheets 414, respectively.

However, such a combing position may vary depending on the user's selection. For example, although the second stack of one-side-bound inner paper sheets 410 is shown on the right side on the inner face of the main outermost cover sheet 402, the second stack of one-side-bound inner paper sheets 410 may be disposed on the left side on the inner side of the main outermost cover sheet 402. In some cases, additional stacks of one-side-bound inner paper sheets may be joined to both the left and right sides on the inner face of the main outermost cover sheet 402. In this case, all five stacks of one-side-bound inner paper sheets may be used.

Further, Thus, all of the first stack of one-side-bound inner paper sheets 408, the second stack of one-side-bound inner paper sheets 410, the third stack of one-side-bound inner paper sheets 412 and the fourth stack of one-side-bound inner paper sheets 414 may be partially inserted into the pockets in the inner faces of the main outermost cover sheet 402 and the left and right sheet extensions 404 and 406.

A first pocket 402a and a second pocket 402b are formed adjacent to and to the left and right sides of the central folding line of the outermost cover sheet 402, respectively. A third pocket 402c and a fourth pocket 402d are formed on the left side of the first pocket 402a and the right side of the second pocket 402b, respectively.

A fifth pocket 402e and a sixth pocket 402f are formed on the left and right sides of the third pocket 402c and the fourth pocket 402d and adjacent to the left and right edges of the outermost cover sheet 402 respectively.

In the left longitudinal cover sheet extension 404, a seventh pocket 404a is formed adjacent to the right edge of the longitudinal cover sheet extension 404, while an eighth pocket 404b is formed adjacent to the left edge of the extension 404. In the right longitudinal cover sheet extension 406, a ninth pocket 406a is formed adjacent to the left edge of the longitudinal cover sheet extension 406, while an tenth pocket 406b is formed adjacent to the right edge of the extension 406.

Left and right pockets are thus formed in the inner face of each of the front and rear portions of the main outermost cover sheet 402 and each of the right and left longitudinal cover sheet extensions 406 and 404. This allows the user to arbitrarily change the coupling location of the selected stack of one-side-bound inner paper sheets.

Referring to FIG. 28, when the main outermost cover sheet 402 is unfolded to the left and right, and the first stack of one-side-bound inner paper sheets 408 is folded, this exposes the left longitudinal cover sheet extension 404 and right longitudinal cover sheet extension 406, respectively. The longitudinal cover sheet extension 404 and the longitudinal cover sheet extension 406 cover underlying stacks of one-side-bound inner paper sheets. As shown in FIG. 29, when the longitudinal cover sheet extension 404 and the longitudinal cover sheet extension 406 are unfolded, the second stack of one-side-bound inner paper sheets 412 is exposed adjacent to the right side of the first stack of one-side-bound inner paper sheets 408. Adjacent to the left side of the first stack of one-side-bound inner paper sheets 408, the third stack of one-side-bound inner paper sheets 412 is exposed. Adjacent to the right side of the second stack of one-side-bound inner paper sheets 412, the fourth stack of one-side-bound inner paper sheets 414 is exposed.

To achieve the above configuration, a first sheet 408a and a last sheet 408b of the first stack of one-side-bound inner paper sheets 408 are inserted into the first pocket 402a and the second pocket 402b, respectively. Further, a last sheet 410b of the second stack of one-side-bound inner paper sheets 410 is inserted into the fourth pocket 402d, while the first sheet 412a of the third stack of one-side-bound inner paper sheets 412 is inserted into the seventh pocket 404a formed in the longitudinal cover sheet extension 404. Finally, the last sheet 414b of the fourth stack of one-side-bound inner paper sheets 414 is inserted into the ninth pocket 406a formed in the longitudinal cover sheet extension 406.

In this case, each of the stacks of one-side-bound inner paper sheets may be unfolded, as shown in FIG. 31.

In some cases, the user may change the correspondence between the pockets and the stacks.

For example, the first sheet 410a of the second stack of one-side-bound inner paper sheets 410 is inserted into the sixth pocket 402f, and the last sheet 412b of the third stack of one-side-bound inner paper sheets 412 is inserted into the eighth pocket 404b. Finally, the first sheet 414a of the fourth stack of one-side-bound inner paper sheets 414 is inserted into the tenth opocket 406b.

In this case, the stacks of one-side-bound inner paper sheets may be unfolded in the opposite directions, as shown in FIG. 32.

In this way, depending on the correspondence between the pockets and the stacks of one-side-bound inner paper sheets, the directions in which the stacks of one-side-bound inner paper sheets are unfolded may vary. Left and right pockets are thus formed in the inner face of each of the front and rear portions of the main outermost cover sheet 402 and each of the right and left longitudinal cover sheet extensions 406 and 404. This allows the user to arbitrarily change the coupling location of the selected stack of one-side-bound inner paper sheets.

Reference numerals 408c, 410c, 412c, and 414c, which are not described above, represent first writable paper sheets, second writable paper sheets, third writable paper sheets, and fourth writable paper sheets, respectively.

In this fourth embodiment, the configuration, material, and coupling of the outermost cover sheet and the stacks of one-side-bound inner paper sheets and pockets are the same as in the previous embodiments.

When only the main outermost cover sheet 402 is unfolded, the user may use the first stack of one-side-bound inner paper sheets 408. When the longitudinal cover sheet extension 404 or the longitudinal cover sheet extension 406 is unfolded, the user may use the remaining stacks of one-side-bound inner paper sheets.

When not using the notebook 400 of the present disclosure, the outermost cover sheet 402 and the extensions 404 and 406 may be folded. An unfolding-prevention band 416 covering the outside face of the outermost cover sheet 402 may prevent the outermost cover sheet 402 in a folded state from being unfolded. The unfolding-prevention band 416 may be formed of an elastic material and may be configured to simultaneously enclose the front and back faces of the outermost cover sheet 402.

A pen holder 418 for receiving a writing instrument including a ballpoint pen or pencil is attached to one edge of the outermost cover sheet 402.

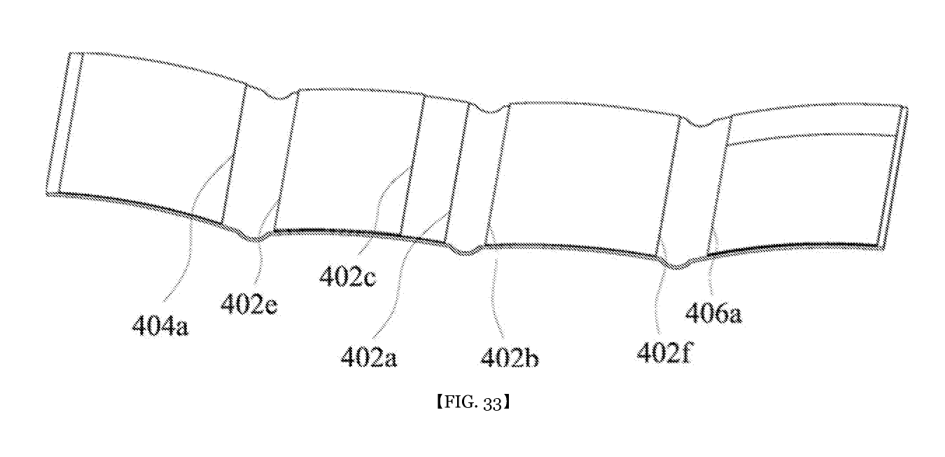

FIGS. 33 to 35 are perspective views showing positions of the pockets according to other embodiments.

Although the first stack of one-side bound inner paper sheets 408, the second stack of one-side bound inner paper sheets 410, and the third stack of one-side bound inner paper sheets 412 and the third stack of one-side bound inner paper sheets 414 may be partially inserted into respective separate pockets, the present invention is not limited to this. At least two of the first stack of one-side bound inner paper sheets 408, the second stack of one-side bound inner paper sheets 410, and the third stack of one-side bound inner paper sheets 412 and the third stack of one-side bound inner paper sheets 414 may be partially inserted into one pocket.

As shown in FIG. 33, the fourth pocket 402d is removed, and the first stack of one-side bound inner paper sheets 408 and the second stack of one-side bound inner paper sheets 410 may be partially inserted together in the second pocket 402b.

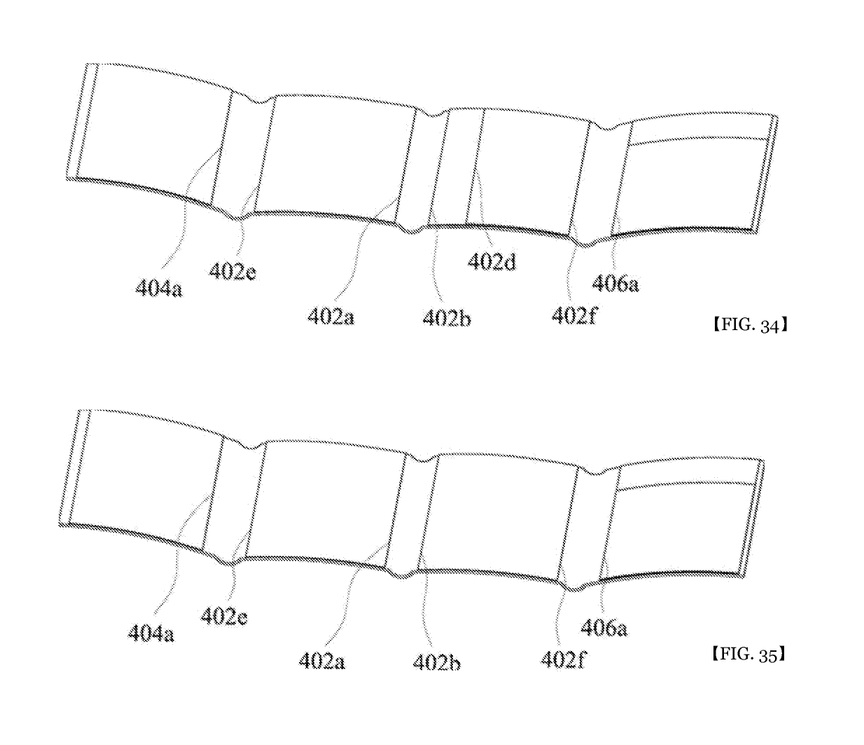

Further, as shown in FIG. 34, the third pocket 402c is removed, and the first stack of one-side bound inner paper sheets 408 and the third stack of one-side bound inner paper sheets 412 may be partially inserted into the first pocket 402a together.

Further, as shown in FIG. 35, the third pocket 402c and the fourth pocket 402d are all removed. In this connection, selected stacks may be partially inserted together into the first pocket 402a, while further selected stacks may be partially inserted together in the second pocket 402b.

The features, structures, effects, and the like described in the embodiments are included in at least one embodiment and are not necessarily limited to one embodiment. Furthermore, the features, structures, effects, etc. illustrated in the various embodiments may be combined or modified in other embodiments by those skilled in the art to which the embodiments belong. Accordingly, the details of such combinations and modifications are to be construed as included within the scope of the embodiments. Having described the invention with reference to the above embodiments, it is to be understood that such embodiments are merely illustrative and not restrictive of the present disclosure. Those of ordinary skill in the art to which the embodiment belongs will recognize that various modifications and substitutions to the extent not inconsistent with the present invention may be made without departing from the essential characteristics of the present embodiments. For example, each component specifically illustrated in the embodiment may be modified. It is also to be understood that such variations and substitutions are intended to be included within the scope of the embodiments as defined in the appended claims.

1. (canceled)

2. A notebook system comprising:
an outermost cover sheet, wherein a first pocket and a second pocket are formed in an inner face of the sheet and are adjacent to left and right sides of a central folding line of the outermost cover sheet, respectively, wherein the cover sheet is folded or unfolded in a longitudinal direction around the folding line;
a transverse sheet extension further foldably coupled to the outermost cover sheet, wherein the transverse sheet extension is folded or unfolded in a transverse direction perpendicular to the longitudinal direction, wherein the extension extends from a top or bottom edge of the cover sheet;
a first stack of one-side-bound inner paper sheets, wherein a first sheet and a last sheet of the first stack of one-side-bound inner paper sheets are removably inserted into the first pocket and the second pocket, respectively, wherein the first stack has first writable paper sheets between the first and last sheets and of the first stack; and
a second stack of one-side-bound inner paper sheets, wherein a last paper sheet of the second stack of one-side-bound inner paper sheets is removably inserted into a third pocket, wherein the third pocket is formed in an outer face of the sheet, wherein the second stack has second writable paper sheets between first and last sheets of the second stack,
wherein each of the first and second stacks is embodied as a blank paper sheets stack or an underlined paper sheets stack or a printed book having content printed thereon.

3. A notebook system comprising:
an outermost cover sheet, wherein a first pocket and a second pocket are formed in an inner face of the sheet and are adjacent to left and right sides of a central folding line of the outermost cover sheet, respectively, wherein a third pocket c and a fourth pocket are formed in the inner face of the sheet and are adjacent to a left side of the first pocket and to a right side of the second pocket, respectively, wherein a fifth pocket and a sixth pocket are formed in the inner face of the sheet and are adjacent to a left edge and a right edge of the sheet, respectively, wherein the cover sheet is folded or unfolded in a longitudinal direction around the folding line;
a longitudinal cover sheet extension coupled to a right edge of the outermost cover sheet, wherein the longitudinal cover sheet extension is folded or unfolded in the longitudinal direction, wherein a seventh pocket is formed in an inner face of the extension and is adjacent to a left edge of the longitudinal cover sheet extension, wherein an eighth pocket is formed in the inner face of the extension and is adjacent to a right edge of the extension;
a first stack of one-side-bound inner paper sheets, wherein a first sheet and a last sheet of the first stack of one-side-bound inner paper sheets are removably inserted into the first pocket and the second pocket, respectively, wherein the first stack has first writable paper sheets disposed between the first and last sheets and;
a second stack of one-side-bound inner paper sheets, wherein a first sheet of the second stack of one-side-bound inner paper sheets is removably inserted into the third pocket, or a last sheet of the second stack of one-side-bound inner paper sheets is removably inserted into the fifth pocket, wherein the second stack has second writable paper sheets disposed between the first and last sheets and of the second stack of one-side-bound inner paper sheets;
a third stack of one-side-bound inner paper sheets, wherein a last sheet of the third stack of one-side-bound inner paper sheets is removably inserted into the fourth pocket, or a first sheet of the third stack of one-side-bound inner paper sheets is removably inserted into the sixth pocket, wherein the third stack has third writable paper sheets disposed between the first and last sheets and of the third stack of one-side-bound inner paper sheets; and
a fourth stack of one-side-bound inner paper sheets, wherein a last sheet of the fourth stack of one-side-bound inner paper sheets is removably inserted into the seventh pocket, or a first sheet of the fourth stack of one-side-bound inner paper sheets is removably inserted into the eight pocket, wherein the fourth stack has fourth writable paper sheets disposed between the first and last sheets and of the fourth stack of one-side-bound inner paper sheets,
wherein each of the first, second, third, and fourth stacks is embodied as a blank paper sheets stack or an underlined paper sheets stack or a printed book having content printed thereon.

4. A notebook system comprising:
an outermost cover sheet, wherein a first pocket and a second pocket are formed in an inner face of the sheet and are adjacent to left and right sides of a central folding line of the outermost cover sheet, respectively,
wherein a third pocket and a fourth pocket are formed in the inner face of the sheet and are adjacent to a left side of the first pocket and to a right side of the second pocket, respectively, wherein a fifth pocket and a sixth pocket are formed in the inner face of the sheet and are adjacent to a left edge and a right edge of the sheet, respectively, wherein the cover sheet is folded or unfolded in a longitudinal direction around the folding line;
a left longitudinal cover sheet extension coupled to a left edge of the outermost cover sheet, wherein the left longitudinal cover sheet extension is folded or unfolded in the longitudinal direction, wherein a seventh pocket is formed in an inner face of the extension and is adjacent to a right edge of the longitudinal cover sheet extension, wherein an eighth pocket is formed in the inner face of the extension and is adjacent to a left edge of the extension;
a right longitudinal cover sheet extension coupled to a right edge of the outermost cover sheet, wherein the right longitudinal cover sheet extension is folded or unfolded in the longitudinal direction, wherein a ninth pocket is formed in an inner face of the extension and is adjacent to a left edge of the longitudinal cover sheet extension, wherein a tenth pocket is formed in the inner face of the extension and is adjacent to a right edge of the extension;
a first stack of one-side-bound inner paper sheets, wherein a first sheet a and a last sheet b of the first stack of one-side-bound inner paper sheets are removably inserted into the first pocket and the second pocket, respectively, wherein the first stack has first writable paper sheets disposed between the first and last sheets and;
a second stack of one-side-bound inner paper sheets, wherein a first sheet of the second stack of one-side-bound inner paper sheets is removably inserted into the sixth pocket, or a last sheet of the second stack of one-side-bound inner paper sheets is removably inserted into the fourth pocket, wherein the second stack has second writable paper sheets disposed between the first and last sheets and of the second stack of one-side-bound inner paper sheets;
a third stack of one-side-bound inner paper sheets, wherein a last sheet of the third stack of one-side-bound inner paper sheets is removably inserted into the eighth pocket, or a first sheet of the third stack of one-side-bound inner paper sheets is removably inserted into the seventh pocket, wherein the third stack has third writable paper sheets disposed between the first and last sheets and of the third stack of one-side-bound inner paper sheets; and
a fourth stack of one-side-bound inner paper sheets, wherein a last sheet of the fourth stack of one-side-bound inner paper sheets is removably inserted into the ninth pocket, or a first sheet of the fourth stack of one-side-bound inner paper sheets is removably inserted into the tenth pocket, wherein the fourth stack has fourth writable paper sheets disposed between the first and last sheets and of the fourth stack of one-side-bound inner paper sheets,
wherein each of the first, second, third, and fourth stacks is embodied as a blank paper sheets stack or an underlined paper sheets stack or a printed book having content printed thereon.
